(19) United States
(12) Patent Application Publication
(10) Pub. No.: US 2013/0164263 A1
(43) Pub. Date: Jun. 27, 2013

(54) Fungus Having Fusarium graminearum Virus FgV1-DK21 Transmitted Thereto for Biological Control and Method for Biological Control Using the Same

(71) Applicant: SNU R&DB FOUNDATION, Seoul (KR)

(72) Inventors: Kook-Hyung KIM, Seoul (KR); Kyung-Mi LEE, Yangsan Si, Gyeongsangnam-Do (KR); Jisuk YU, Jeonju Si, Jeollabuk-Do (KR); Moonil SON, Seoul (KR); Yin-Won LEE, Seoul (KR)

(73) Assignee: SNU R&DB FOUNDATION, Seoul (KR)

(21) Appl. No.: 13/725,460

(22) Filed: Dec. 21, 2012

(30) Foreign Application Priority Data
Dec. 23, 2011 (KR) 110-2011-0141664

(51) Int. Cl. A01N 65/00

(52) U.S. Cl. CPC A01N 65/00
USPC 424/93.5; 435/254.11; 435/454; 435/254.7

(57) ABSTRACT

A fungus, for biological control, having Fusarium graminearum virus 1-DK21 transmitted thereto and a method for biological control using the same and discloses a fungus, for biological control, having an infectious Fusarium virus transmitted thereto, a composition for biological control comprising the same, and a method for biological control using the same. It also provides a method for biological control, which includes bringing a virulent wild-type species into contact with a fungus having a virus inserted therein. It also provides a method of transmitting an infectious Fusarium virus to a vegetatively incompatible strain by a protoplast fusion.

### CROSS-REFERENCE TO RELATED APPLICATION AND CLAIM OF PRIORITY

This application claims priority from Korean Patent Application No. 10-2011-0141664, filed Dec. 23, 2011, in the Korean Intellectual Property Office, the disclosure of which is incorporated herein by reference.

### BACKGROUND

1. Field of the Invention

The present invention relates to a fungus having Fusarium graminearum virus 1-DK21 (FgV1-DK21) transmitted thereto for biological control, a composition for biological control including the same, and a method for biological control using the same.

2. Description of the Prior Art

Although fungicides successfully control many diseases caused by plant-pathogenic fungi, fungal pathogens remain a major source of plant disease. Because of the development of fungicide-resistant strains, and increasing public concern regarding environmental and food safety, there is renewed interest in biological control based on application of hypovirulent mycoviruses.

The potential of mycoviruses for managing plant-pathogenic fungi was first demonstrated for Cryphonectria parasitica. The success of biological control with hypoviruses depends on their ability to reduce the virulence (to induce hypovirulence) of the target fungus. Hypoviruses can be transmitted from a hypovirulent strain to a virulent fungal strain by hyphal fusion (anastomosis) when the two strains are vegetatively compatible, but hypoviruses cannot be transmitted when applied by extracellular routes. Because only closely related fungal strains are vegetatively compatible, vegetative incompatibility among many fungal species in agricultural ecosystems is a major barrier to the use of hypoviruses as biological control agents.

Double-stranded RNA mycoviruses have been described in yeasts, mushrooms, and filamentous fungi. They are classified into five families based on virus structure and genome composition, but some are still unassigned to a genus or in some cases to a family. There is increasing evidence that mycoviruses reduce the growth and pathogenicity of fungal plant pathogens. As noted above, a virulence-attenuating dsRNA molecule has been described in C. parasitica, and five related mycoviruses have been completely sequenced. Among them, Cryphonectria hypovirus 1 (CHV1) was successfully used as a biological control agent of C. parasitica in Europe, i.e., CHV1-infected strains exhibited reduced virulence, reduced asexual and sexual sporulation, and reduced pigment production. CHV1 was unsuccessful as a biological control agent in North America, however, because the host fungus in North America has multiple vegetative compatibility groups (VCGs) that limit the spread of the virus.

The failure of mycovirus transmission caused by vegetative incompatibility can be overcome in the laboratory by using protoplast fusion. Transmission of dsRNA mycoviruses via protoplast fusion has been reported in plant-pathogenic fungi including Aspergillus, F. poae, and Rosellinia necatrix.

The present inventors previously isolated the FgV1-DK21 virus from strain DK21 (Chu Y-M, Jeon J-J, Yea S-J, Kim Y-H, Yun S-H, et al. (2002), Double-stranded RNA mycovirus from Fusarium graminearum. Appl Environ Microbiol 68:2529-2534). According to genealogical concordance phylogenetic species recognition (GCPSR), the F. graminearum species complex (Fg complex) includes 13 phylogenetically distinct species based on DNA sequences from 13 independent genetic loci. Strain DK21 was evaluated by GCPSR using DNA sequences from selected genes and it was identified as F. boothii. FgV1-DK21 reduces the mycelial growth of F. boothii, increases its pigmentation, and reduces its virulence on wheat. The 6,621 nucleotide-coding strand is polyadenylated and contains four open reading frames (ORFs 1 to 4) (Kwon S-J, Lim W-S, Park S-H, Park M-R, Kim K-H (2007) Molecular characterization of a dsRNA mycovirus, Fusarium graminearum virus-DK21, which is phylogenetically related to hypoviruses but has a genome organization and gene expression strategy resembling those of plant potex-like viruses. Mol Cells 23: 304-315). Pairwise sequence comparisons of the nucleotide and deduced amino acid sequences of ORFs 2 through 4 revealed no close relationships to other protein sequences currently available in GenBank while a phylogenetic analysis of the deduced amino acid sequence of ORF1, which encodes a putative RNA-dependent RNA polymerase (RdRp), and those of other mycoviruses revealed that this organism forms a distinct virus Glade with some hypoviruses and is more distantly related to other mycoviruses. While FgV1-DK21 does not encode a coat protein, the genome organization and accumulation of at least two subgenomic RNAs (sgRNAs) indicate that FgV1-DK21 belongs to a new, as yet unassigned genus of mycoviruses.

The present inventors have found that protoplast fusion can be used to expand hypovirus host range and to study hypovirus-mediated alterations in new fungal hosts, thereby completing the present invention.

Throughout the specification, a number of publications and patent documents are referred to and cited. The disclosure of the cited publications and patent documents is incorporated herein by reference in its entirety to more clearly describe the state of the related art and the present disclosure.

Korean Patent Application No. 10-2010-7018484 relates to a novel mycovirus, a phytopathogenic fungus-attenuating strain, a plant disease-controlling agent, a mycovirus-producing method, a phytopathogenic fungus-attenuating method and a plant disease-controlling agent and discloses a novel mycovirus that inhibits rice blast fungi. However, it discloses neither the use of Fusarium graminearum virus 1-DK21 (FgV1-DK21) nor the inhibition of Fusarium sp. strain by protoplast fusion.

### SUMMARY

It is an aspect of the present invention to provide a fungus, for biological control, having an infectious Fusarium virus transmitted thereto, a composition for biological control including the same, and a method for biological control using the same.

Another aspect of the present invention is to provide a method for biological control, which includes bringing virulent wild-type species into contact with a fungus having virus inserted therein.

Still another aspect of the present invention is to provide a method of transmitting an infectious Fusarium virus to a vegetatively incompatible strain by a protoplast fusion method.

Other aspects and advantages of the present invention will be more clearly understood by reference to the following description, the appended claims and the accompanying drawings.

In a first aspect, the present invention provides a fungus, for biological control, having an infectious Fusarium virus transmitted thereto.

Specifically, the infectious Fusarium virus may be any one virus selected from the group consisting of Fusarium graminearum virus 1-DK21 (FgV1-DK21), Fusarium graminearum virus 2, Fusarium graminearum virus 3, and Fusarium graminearum virus 4. More specifically, the infectious Fusarium virus may be Fusarium graminearum virus 1-DK21 (FgV1-DK21).

In addition, the fungus may be a Fusarium sp. fungus. More specifically, the fungus may be F. asiaticum or F. oxysporum f. sp. lycopersici. Further, the fungus may also be Cryphonectria parasitica.

In a second aspect, the present invention provides a composition for biological control including the above fungus, and a method for biological control using the same.

The composition for biological control includes at least any one of the infectious Fusarium virus according to an embodiment of the present invention and the fungus for biological control according to an embodiment of the present invention. In addition, the composition for biological control may contain both the infectious Fusarium virus according to an embodiment of the present invention and the fungus for biological control according to an embodiment of the present invention, as well as other components. Examples of the other components include carriers, binders, thickeners, fixing agents, antifungal preservatives, solvents, stabilizers, antioxidants, UV blockers, crystal precipitation inhibitors, defoaming agents, property enhances, coloring agents, and the like. In addition, the composition may also contain other agricultural chemicals, for example, acaricide, nematocides, microbicides, antiviral agents, attractants, herbicides, plant growth regulators, synergists, and the like.

The carriers that may be used in the composition of an embodiment of the present invention may be, for example, solid and/or liquid carriers. Examples of the solid carriers include animal and vegetable powders, including starch, activated carbon, soybean powder, wheat powder, wood powder, fish powder or milk powder, mineral powders, including talc, kaolin, bentonite, zeolite, diatomaceous earth, white carbon, clay, alumina, calcium carbonate, potassium chloride or ammonium sulfate, and so on. Examples of the liquid carriers water, alcohols such as isopropylalcohol or ethyleneglycol, ketones such as cyclohexanone or methylethylketone, ethers such as propyleneglycol monomethylether or diethyleneflycolmono-n-butylether, aliphatic hydrocarbons such as kerosene or light oil, aromatic hydrocarbons such as xylene, trimethylbenzene, tetramethylbenzene, methylnaphthalene or solvent naphtha, amides such as N-methyl-2-pyrrolidone, esters such as fatty acid glycerin ester, vegetable oils such as soybean oil or rapeseed oil, and the like.

Examples of binders, thickeners or fixing agents which may be used in the composition of the present invention include dextrin, cellulose, methylcellulose, ethylcellulose, carboxyethylcellulose, hydroxyethylcellulose, hydroxypropylcellulose, hydroxypropylmethylcellulose, carboxymethyl starch, pullulan, sodium alginate, ammonium alginate, propylene glycol ester alginate, guar gum, locust bean gum, gum Arabia, xanthan gum, gelatin, casein, polyvinyl alcohol, polyethylene oxide, polyethylene glycol, ethylene/propylene block polymers, sodium polyacrylate, polyvinylpyrrolidone and the like.

The formulation of the composition of the present invention is not specifically limited. For example, the composition of the present invention may be formulated in the form of emulsion, suspensions, powders, granules, tablets, hydrated agents, water-soluble agents, liquid agents, flowable agents, hydrated granules, aerosols, pastes, oils, emulsions, and the like.

The biological control method according to an embodiment of the present invention includes adding the composition of an embodiment of the present invention to a specific plant. Examples of a method of adding the composition of an embodiment of the present invention to a specific plant include applying the composition to the surface of leaves, a method of attaching the composition to the surface of leaves using a specific carrier, spreading or supplying the composition to leaves, and the like.

The amount of composition applied or spread can be suitably selected depending on various factors, including the concentration of the active ingredient, the type of formulation, the kind of plant disease or crop to be treated, the degree of damage by plant disease, the place of use, the method of application, the timing of application, the amount and kind of chemical or fertilizer used in combination, and the like. The composition of an embodiment of the present invention may be applied or attached to the surface of leaves, thereby controlling plant disease.

The present invention can be applied to all types of plant diseases which are caused mainly by fungi Fusarium sp.-related plant diseases to which the composition of an embodiment of the present invention can be applied include wilt disease in Fabaceae plants, the Fusarium wilt, wilt, dry rot and brown rot in potatoes and similar plants, Fusarium wilt in Cucurbitaceae plants, the wilt, root rot, half wilt and wilt in Solanaceae plants, and Fusarium wilt in Brassicaceae plants, and the like.

In a third aspect, the present invention provides a method for biological control, which includes bringing virulent wild-type species into contact with the fungus having virus inserted therein. Specifically, the virulent wild-type species may be a Fusarium sp. strain. More specifically, it may be F. asiaticum or F. oxysporum f. sp. lycopersici. In addition, the virulent wild-type species may also be Cryphonectria parasitica.

In an embodiment of the present invention, a method for inserting virus involves the uptake of the virus directly by protoplasts or cells. This insertion can be performed by polyethylene glycol (PEG) or electroporation-mediated uptake, particle bombardment-mediated delivery or microinjection.

In a forth aspect, the present invention provides a method of transmitting an infectious Fusarium virus to a vegetatively incompatible strain by a protoplast fusion method.

Specifically, the infectious Fusarium virus may be any one virus selected from the group consisting of Fusarium graminearum virus 1-DK21 (FgV1-DK21), Fusarium graminearum virus 2, Fusarium graminearum virus 3, and Fusarium graminearum virus 4. More specifically, it may be Fusarium graminearum virus 1-DK21 (FgV1-DK21).

In addition, the fungus may be a Fusarium sp. fungus. More specifically, the fungus may be F. asiaticum or F. oxysporum f. sp. lycopersici. Further, it may also be Cryphonectria parasitica.

More specifically, the present invention provides a method of transmitting FgV1-DK21 virus to a vegetatively incompatible strain, the method including: preparing the protoplast of a donor strain including Fusarium graminearum virus 1-DK21 (FgV1-DK21) and the protoplast of a recipient strain; fusing the protoplast of the donor strain with the protoplast of the recipient strain; and selecting an FgV1-DK21 virus-infected strain on a selective medium.

### BRIEF DESCRIPTION OF THE DRAWINGS

FIGS. 1A and 1B show transformation of F. graminearum with a hygromycin B resistance gene. FIG. 1A shows the southern blot hybridization of Kpn I-digested genomic DNAs. Hygromycin B-resistant transformants were obtained by transforming the fungal protoplasts with the plasmid pUCH1. The probe used was EcoR I and Hind III fragment (1.4 kb) from pUCH1 bearing the hygB structural gene. Lane M, 1 DNA-Hind III digested DNA marker; lane 1, wild-type; lane 2, hygromycin B-resistant strain; lane 3, virus-infected strain (protoplast fusant). FIG. 1B shows the photograph of fungal colonies 4 days after inoculation.

FIGS. 2A through 2C show construction of virus-infected G418-resistant mutant. FIG. 2A shows the strategy of construction of G418-resistant mutant. FIG. 2B shows the southern blotting of Kpn I and Spe I-digested genomic DNAs, hybridized with a 1.9 kb geneticin probe. Lane M, λ DNA-Hind III digested DNA marker; lane 1, wild-type; lane 2, G418-resistant strain; lane 3, virus-infected strain (G418-selected). FIG. 2C shows the colony morphology of virus-free and -infected of wild-type and G418-resistant strains 5 days after inoculation.

FIGS. 3A and 3B show the phenotype of fungal colonies and reverse-transcription polymerase chain reaction (RT-PCR) analysis of Fusarium strains.

Fb=F. boothii; Fg=F. graminearum; Fa=F. asiaticum; Fo=F. oxysporum f. sp. lycopersici. FIG. 3A shows the colony morphology of virus-free (VF) and virus-infected (VI) strains by protoplast fusion. FIG. 3B shows the RT-PCR analysis of dsRNA in fungal strains. Lane M, 1-kb ladder DNA size marker; lane 1, negative control (no DNA template); lanes 2, 4, 6, and 8, virus-free strains; lanes 3, 5, 7, and 9, virus-infected strains. Presence of viral dsRNA was confirmed by RT-PCR amplification with a primer pair designed from the RdRp sequence of FgV1-DK21.

FIGS. 4A and 4B show the alignments of histone H3 sequences from F. asiaticum (FIG. 4A) and F. graminearum (FIG. 4B) strains. VF=virus-free; VI=virus-infected. The fixed nucleotide characters are shaded in green. The presence of nucleotides G (position 278) and T (position 279) is differentially fixed for F. asiaticum and F. graminearum, respectively. GenBank accession numbers of nucleotide sequences used are as follows: NRRL 6101 (AY452820.1), NRRL 13818(AY452821.1), NRRL 26156 (AY452843.1), NRRL 28720 (AY452844.1), NRRL 5883 (AY452815.1), NRRL 6394 (AY452817.1), NRRL 13383 (AY452819.1), NRRL 28063 (AY452816.1), NRRL 28336 (AY452818.1), NRRL 29169 (AY452836.1), NRRL 31084 (AY452852.1).

FIGS. 5A and 5B show the disease symptoms in wheat head spikelets inoculated with fungal strains belonging to the Fusarium graminearum species complex. Conidial suspensions of each strain either uninfected or infected with FgV1-DK21 were used to inoculate wheat plants. Error bars indicate standard deviation.

FIGS. 6A and 6B show the virulence of virus-free (VF) and virus-infected (VI) strains of F. oxysporum f. sp. lycopersici on tomato seedlings. FIG. 6A shows the disease severity caused by fungal strains 3 weeks after inoculation. Disease index was scored on a scale of 0-4: 0, healthy plant; 1, slightly swollen and/or bent hypocotyl; 2, one brown vascular bundle in hypocotyl; 3, at least two brown vascular bundles and/or severe growth distortion (asymmetric development); 4, at least three brown vascular bundles and/or very small, wilted plant (or dead). Data were analyzed by the General Lineal Model (GLM) using PASW statistics 18.0 for Windows software (SPSS Inc.). Error bars indicate standard deviation. Different letters above the bars indicate significant differences at p≦0.05. FIG. 6B shows the photograph of tomato seedlings 4 weeks after inoculation.

FIGS. 7A and 7B show the phenotype and growth rate of C. parasitica as affected by transmission of dsRNA. Colony morphology (FIG. 7A) and RT-PCR analysis (FIG. 7B). EP155 (hygromycin B-resistant mutant), virus-free C. parasitica strain; UEP, EP155 infected with CHV1; 1 to 4, EP155 infected with FgV1-DK21. Lane M, λ DNA-Hind III digested DNA marker; NC, no DNA template.

FIGS. 8A and 8B show the virulence of C. parasitica strains on apples 3 weeks after inoculation. FIG. 8A shows the cankers induced by each strain on apples. Apples were inoculated with fresh cultures of strain EP 155 either uninfected (EP 155) or infected with CHV1 (UEP) or infected with FgV1-DK21 (1 to 4). FIG. 8B show the size of cankers produced by the fungal strains. Error bars indicate standard deviation.

### DETAILED DESCRIPTION

Hereinafter, the present invention will now be described in detail with reference to examples. However, these examples are not intended to limit the scope of the present invention as defined in the appended claims.

In a first aspect, the present invention provides a fungus, for biological control, having an infectious Fusarium virus transmitted thereto.

Specifically, the infectious Fusarium virus may be any one virus selected from the group consisting of Fusarium graminearum virus 1-DK21 (FgV1-DK21), Fusarium graminearum virus 2, Fusarium graminearum virus 3, and Fusarium graminearum virus 4. More specifically, the infectious Fusarium virus may be Fusarium graminearum virus 1-DK21 (FgV1-DK21).

In addition, the fungus may be a Fusarium sp. fungus. More specifically, the fungus may be F. asiaticum or F. oxysporum f. sp. lycopersici. Further, the fungus may also be Cryphonectria parasitica.

In a second aspect, the present invention provides a composition for biological control including the above fungus, and a method for biological control using the same.

The composition for biological control includes at least any one of the infectious Fusarium virus according to the present invention and the fungus for biological control according to the present invention. In addition, the composition for biological control may contain both the infectious Fusarium virus according to the present invention and the fungus for biological control according to the present invention, as well as other components. Examples of the other components include carriers, binders, thickeners, fixing agents, antifungal preservatives, solvents, stabilizers, antioxidants, UV blockers, crystal precipitation inhibitors, defoaming agents, property enhances, coloring agents, and the like. In addition, the composition may also contain other agricultural chemicals, for example, acaricide, nematocides, microbicides, antiviral agents, attractants, herbicides, plant growth regulators, synergists, and the like.

The carriers that may be used in the composition of the present invention may be, for example, solid and/or liquid carriers. Examples of the solid carriers include animal and vegetable powders, including starch, activated carbon, soybean powder, wheat powder, wood powder, fish powder or milk powder, mineral powders, including talc, kaolin, bentonite, zeolite, diatomaceous earth, white carbon, clay, alumina, calcium carbonate, potassium chloride or ammonium sulfate, and so on. Examples of the liquid carriers water, alcohols such as isopropylalcohol or ethyleneglycol, ketones such as cyclohexanone or methylethylketone, ethers such as propyleneglycol monomethylether or diethyleneflycolmono-n-butylether, aliphatic hydrocarbons such as kerosene or light oil, aromatic hydrocarbons such as xylene, trimethylbenzene, tetramethylbenzene, methylnaphthalene or solvent naphtha, amides such as N-methyl-2-pyrrolidone, esters such as fatty acid glycerin ester, vegetable oils such as soybean oil or rapeseed oil, and the like.

Examples of binders, thickeners or fixing agents which may be used in the composition of the present invention include dextrin, cellulose, methylcellulose, ethylcellulose, carboxyethylcellulose, hydroxyethylcellulose, hydroxypropylcellulose, hydroxypropylmethylcellulose, carboxymethyl starch, pullulan, sodium alginate, ammonium alginate, propylene glycol ester alginate, guar gum, locust bean gum, gum Arabia, xanthan gum, gelatin, casein, polyvinyl alcohol, polyethylene oxide, polyethylene glycol, ethylene/propylene block polymers, sodium polyacrylate, polyvinylpyrrolidone and the like.

The formulation of the composition of the present invention is not specifically limited. For example, the composition of the present invention may be formulated in the form of emulsion, suspensions, powders, granules, tablets, hydrated agents, water-soluble agents, liquid agents, flowable agents, hydrated granules, aerosols, pastes, oils, emulsions, and the like.

The biological control method according to the present invention includes a step of adding the composition of the present invention to a specific plant. Examples of a method of adding the composition of the present invention include a method of applying the composition to the surface of leaves, a method of attaching the composition to the surface of leaves using a specific carrier, a method of spreading or supplying the composition to leaves, and the like.

The amount of composition applied or spread can be suitably selected depending on various factors, including the concentration of the active ingredient, the type of formulation, the kind of plant disease or crop to be treated, the degree of damage by plant disease, the place of use, the method of application, the timing of application, the amount and kind of chemical or fertilizer used in combination, and the like. The composition of the present invention may be applied or attached to the surface of leaves, thereby controlling plant disease.

The present invention can be applied to all types of plant diseases which are caused mainly by fungi. Fusarium sp.-related plant diseases to which the composition of the present invention include wilt disease in Fabaceae plants, the Fusarium wilt, wilt, dry rot and brown rot in potatoes and similar plants, Fusarium wilt in Cucurbitaceae plants, the wilt, root rot, half wilt and wilt in Solanaceae plants, and Fusarium wilt in Brassicaceae plants, and the like.

In a third aspect, the present invention provides a method for biological control, which includes bringing virulent wild-type species into contact with the fungus having virus inserted therein. Specifically, the virulent wild-type species may be a Fusarium sp. strain. More specifically, it may be F. asiaticum or F. oxysporum f. sp. lycopersici. In addition, the virulent wild-type species may also be Cryphonectria parasitica.

In the present invention, methods for inserting virus involve the uptake of the virus directly by protoplasts or cells. This insertion can be performed by PEG or electroporation-mediated uptake, particle bombardment-mediated delivery or microinjection.

In a forth aspect, the present invention provides a method of transmitting an infectious Fusarium virus to a vegetatively incompatible strain by a protoplast fusion method.

Specifically, the infectious Fusarium virus may be any one virus selected from the group consisting of Fusarium graminearum virus 1-DK21 (FgV1-DK21), Fusarium graminearum virus 2, Fusarium graminearum virus 3, and Fusarium graminearum virus 4. More specifically, it may be Fusarium graminearum virus 1-DK21 (FgV1-DK21).

In addition, the fungus may be a Fusarium sp. fungus. More specifically, the fungus may be F. asiaticum or F. oxysporum f. sp. lycopersici. Further, it may also be Cryphonectria parasitica.

More specifically, the present invention provides a method of transmitting FgV1-DK21 virus to a vegetatively incompatible strain, the method including the steps of preparing the protoplast of a donor strain including Fusarium graminearum virus 1-DK21 (FgV1-DK21) and the protoplast of a recipient strain; fusing the protoplast of the donor strain with the protoplast of the recipient strain; and selecting an FgV1-DK21 virus-infected strain on a selective medium.

Exemplary embodiments will be described to more concretely understand the present invention with reference to examples and comparative examples. However, it will be apparent to those skilled in the art that such embodiments are provided for illustrative purposes and do not limit subject matters to be protected as defined by the appended claims.

### EXAMPLES

### Material and Methods

Fungal Strains and Culture Conditions

All strains used in this study (Table 1) were stored in 25% (v/v) glycerol at −80° C. and were reactivated on potato dextrose agar (PDA; Difco). For total RNA extraction, strains of the Fg complex were grown in 50 ml of liquid complete medium (CM) at 25° C. at 150 r.p.m. for 5 days while strains of C. parasitica were grown in 50 ml of EP complete medium at 26° C. and 120 r.p.m. for 5 days. Mycelia were harvested by filtration through Miracloth (Calbiochem) and ground to a fine powder with a mortar and pestle in liquid nitrogen.

TABLE 1
Strains included in this example

| Taxon | Characteristics^{a} | Reproduction |
|---|---|---|
| F. boothii (Fb) | Strain DK2 1; vius-free | Homothallic |
| | and virus-infected | |
| | (Gen^{R}) | |
| F. asiaticum (Fa) | Strain 88-1 (HygB^{R}) | Homothallic |
| F. graminearum (Fg) | Strain DK3; virus-free | Homothallic |
| | (Hyg^{R}) | |
| F. oxysporum f. sp. lycopersici (Fo) | HygB^{R} | Asexual |
| Cryphonectria parasitica (Cp) | HygB^{R} | Heterothallic |

^{a}HygB^{R}, resistant to hygromycin B; Gen^{R}, resistant to G418. Virus-free strains derived from strain DK21 and DK3 were obtained by single conidial isolation

Construction of Antibiotic Resistant Mutants

Protoplasts of fungal strains were prepared by treatment of fresh mycelia grown on YPG liquid medium (0.3% yeast extract, 1% peptone, 2% glucose) for 3 hours at 30° C. with 1M NH₄Cl containing 10 mg/ml of driselase (InterSpex Products). Plasmid DNA (20 mg) was directly added along with 1 ml of PEG solution (60% polyethylene glycol 3350, 10 mM Tris-HCl pH 7.5, 10 mM CaCl₂) to protoplast suspensions. Transformants with resistance to hygromycin B were obtained by transforming the fungal protoplasts with the plasmid pUCH1 and selected for on regeneration medium containing 80 μg/ml of hygromycin B (Calbiochem). For construction of the geneticin-resistant mutant, the plasmid pII99 was transformed into protoplasts of virus-free F. boothii. Following the transformation, FgV1-DK21 was transmitted by anastomosis and screened on PDA containing 50 mg/ml of geneticin (Duchefa). For genomic DNA extraction, fungal strains of the Fg complex were grown in 50 ml of CM at 25° C., 150 r.p.m. for 5 days. The mycelia were harvested by filtration through sterile Whatman No. 2 filter paper, ground in liquid nitrogen using a mortar and pestle, and then suspended in CTAB buffer [2% CTAB (cetyltrimethyl ammonium bromide), 20 mM EDTA, 0.1 M Tris-HCl, and 1.4 M NaCl]: 2-mercaptoethanol (100:1). Genomic DNA was extracted sequentially with chloroform:isoamyl alcohol (24:1), precipitated with isopropanol. The extracted genomic DNA was extracted twice with phenol:chloroform:isoamyl alcohol (25:24:1), treated with RNase A (20 mg/ml) for 1 h at 37° C., precipitated with isopropanol, and then finally suspended in distilled water. For the Southern hybridization of hygromycin B-resistant mutants, the extracted genomic DNA was digested with Kpn I for 12 h, and the Southern hybridization of G418-resistant mutants, it was digested with Spe I and Kpn I for 12 h at 37° C. A 10-ml of the digested DNA was separated on 0.8% agarose gel for 8 h. The gel was submerged twice in denaturation solution (1.5 M NaCl and 0.5 N NaOH) for 20 min at room temperature and capillary blotted onto a positively charged nylon transfer membrane (GE Healthcare) in 0.4 N NaOH. Probe labeling reactions were performed in 20 ml of 10 mM Tris-HCl pH 7.5, 7 mM MgCl₂, 0.1 mM DTT, 30 μCi [α-³²P] dCTP, 3 mM dNTP mix, 10 pmoles of random primers and 2 U klenow fragment (TaKaRa). After hybridization, unhybridized probe is removed by washing in low stringency wash buffer (2×SSC and 0.1% SDS) and high stringency wash buffer (0.1×SSC and 0.1% SDS). Hybridization signal intensities were measured using a Bio-imaging Analyzer system (BAS-2500; Fuji Film).

Polymerase Chain Reaction (PCR) and Nucleotide Sequencing

PCR of translation elongation factor 1α (TEF) and histone H3 gene region was performed as described in the references (ODonnell K, Ward T J, Geiser D M, Kistler H C, Aoki T (2004) Genealogical concordance between the mating type locus and seven other nuclear genes supports formal recognition of nine phylogenetically distinct species within the Fusarium graminearum clade. Fungal Genet Biol 41: 600-623; Geiser D M, Jime´nez-Gasco MdM, Kang S, Makalowska Veeraraghavan N, et al. (2004) FUSARIUM-ID v. 1.0: A DNA sequence database for identifying Fusarium. Eur J Plant Pathol 110: 473-479; and Hong S-Y, Kang M R, Cho E-J, Kim H-K, Yin S-H (2010) Specific PCR detection of four quarantine Fusarium species in Korea. Plant Pathol J 26: 409-416) which are incorporated herein by reference, with modification using the following conditions: one step at 94° C. for 3 min; 35 cycles at 93° C. for 45 sec, 55° C. for 40 sec, and 72° C. for 1 min; and finally one step at 72° C. for 10 min. PCR products amplified from fungal strains of the Fg complex were extracted from an agarose gel with QIAquick™ gel extraction kit (Qiagen) by following the manufacturer's instructions. DNA sequencing was performed at the National Instrumentation Center for Environmental Management of the Seoul National University with an ABI Prism 3730 XL DNA Analyzer (Applied Biosystems) according to manufacturer's instructions. The sequence data were analyzed using a BLAST search tool and were aligned using Clustal W.

Protoplast Fusion

Protoplast fusion was performed according to a method described in Kanematsu S, Arakawa M, Oikawa Y, Onoue M, Osaki H, et al. (2004) A reovirus causes hypovirulence of Rosellinia necatrix. Phytopathology 94: 561-568, which is incorporated herein by reference, with modifications. Young mycelia were prepared as described in Lee T, Han Y-K, Kim K-H, Yun S-H, Lee Y-W (2002) Tri13 and Tri7 determine deoxynivalenol- and nivalenol-producing chemotypes of Gibberella zeae. Appl Environ Microbiol 68: 2148-2154, and Churchill A C L, Ciuffetti L M, Hansen D R, Van Etten H D, Van Alfen N K (1990) Transformation of the fungal pathogen Cryphonectria parasitica with a variety of heterologous plasmids. Curr Genet. 17: 25-31, which are incorporated herein by reference and incubated for 3 hours at 30° C. with 1 M NH₄Cl containing 5 mg/ml of driselase and 8 mg/ml of lysing enzyme (L1412; Sigma). Protoplasts were harvested by centrifugation at 2,5446 g at 4° C. for 10 min, washed twice with STC (1.2 M Sorbitol, 10 mM Tris-HCl pH 7.5, 50 mM CaCl₂), and suspended in 300 ml of MMC buffer (0.6 M Mannitol, 10 mM MOPS pH 7.0, and 10 mM CaCl₂). Equal volumes of the two protoplast suspensions (100 μl of 1×10⁷ protoplasts/ml) were mixed and placed on ice for 30 min. After 500 ml of PEG solution (60% PEG 3350, 10 mM MOPS pH 7.0, and 10 mM CaCl₂) was added to the protoplast suspension, the mixture was incubated at 20° C. for 20 min. Protoplast fusants were regenerated in 700 ml of potato dextrose broth (PDB; Difco) for 7 days in the dark, plated on 15 ml of YCDA (0.1% yeast extract, 0.1% casein hydrolysate, 0.5% glucose, and 1.5% agar), and then selected on PDA containing 50 μg/ml of hygromycin B and 50 μg/ml of geneticin. Antibiotic-resistant colonies were screened again on hygromycin B-containing PDA.

RNA Extraction and RT-PCR

Total RNA was isolated with extraction buffer according to a method described in Suzuki N, Nuss D L (2002) Contribution of protein p40 to hypovirus-mediated modulation of fungal host phenotype and viral RNA accumulation. J Virol 76: 7747-7759, which is incorporated herein by reference, and further treated with DNase I (TaKaRa) to remove genomic DNA. The samples were precipitated with ethanol and finally suspended in DEPC-treated water. To detect viral dsRNA in virus-infected colonies, cDNAs were synthesized with M-MLV reverse transcriptase (Promega) and oligo d(T) primer. The resulting cDNAs (20 ng of input RNA) were used to detect FgV1-DK21 (using primer pairs 5′-TGTGGGAGAAGAAGTATGGCCT-3′ (SEQ ID NO: 1) and 5′-ATCAGGAACCATTGAAAGAGTCC-3′ (SEQ ID NO: 2) (RdRp region) or 5′-ATGGACACCAAGGATATTTA-3′ (SEQ ID NO: 3) and 5′-TTAGGGGTGCAAGGCCCTTTTC-3′ (SEQ ID NO: 4) (ORF2 region)). PCR reactions were performed using the following conditions: one step at 94° C. for 3 min; 35 cycles at 93° C. for 45 sec, 60° C. for 40 sec, and 72° C. for 1 min 30 sec; and finally one step at 72° C. for 10 min. PCR products were analyzed by 1% agarose gel electrophoresis.

Virulence Assays

Virulence assays with F. boothii, F. asiaticum, and F. graminearum were performed as described in Seong K, Hou Z, Tracy M, Kistler H C, Xu J-R (2005) Random insertional mutagenesis identifies genes associated with virulence in the wheat scab fungus Fusarium graminearum. Phytopathology 95: 744-750, which is incorporated herein by reference, on wheat cv. Jokyoung. The plants were approximately 6 weeks old and had flowering heads. For production of conidial inoculum, five mycelial plugs were incubated in CMC liquid medium (1.5% carboxymethyl cellulose, 0.1% yeast extract, 0.05% MgSO₄.7H₂O, 0.1% NH₄NO₃, and 0.1% KH₂PO₄) at 25° C. and 150 r.p.m. for 5 to 7 days. Conidia were collected by filtering through six layers of sterile cheese cloth. A 10-μl volume of the spore suspension (10⁵ conidia/ml) in 0.01% (v/v) Tween-20 was injected into one floret of each flowering wheat head. Wheat plants inoculated with 0.01% (v/v) Tween-20 alone served as a control. For each treatment, 10 replicate wheat heads were inoculated. Inoculated plants were placed in a growth chamber (25° C., 80% relative humidity, 14/10 h light/dark cycle). Wheat heads were examined for symptoms 14 days post-inoculation.

Virulence of F. oxysporum f. sp. lycopersici strains was measured with a Fusarium wilt assay as described in Di Pietro A, Roncero M I (1998) Cloning, expression, and role in pathogenicity of pg1 encoding the major extracellular endopolygalacturonase of the vascular wilt pathogen Fusarium oxysporum. Mol Plant-Microbe Interact 11: 91-98, which is incorporated herein by reference. Ten-day-old tomato seedlings in the four-leaf stage were inoculated by dipping the roots for 3 min in a suspension containing 10⁵ microconidia/ml of the F. oxysporum f. sp. lycopersici strains in distilled water. Twenty seedlings per treatment were planted in pots containing sterile soil and maintained in a growth chamber at 28° C. with 14/10 h light/dark cycle. Severity of disease symptoms was calculated using an index from 0 (healthy plant) to 4 (dead plant).

Virulence of C. parasitica strains was assayed as described in Fulbright DW (1984) Effect of eliminating dsRNA in hypovirulent Endothia parasitica. Phytopathology 74: 722-724, which is incorporated herein by reference, with minor modifications. Mycelial plugs were prepared from the edge of 7-day-old colonies on PDA. Apple tissues (5 mm diameter×5 mm deep) were removed and the insides were filled with mycelial plugs. Following inoculation, they were sealed with plastic wrap to maintain humidity and incubated at 25° C. with a 12/12 h light/dark cycle. The discolored area was measured at 14 days post-inoculation. All virulence assays were repeated three times. Statistical analysis was performed with the PASW statistics software (SPSS Inc.).

### Example 1

### Effect of FgV1-DK21 dsRNA on Colony Morphology and Mycelial Growth

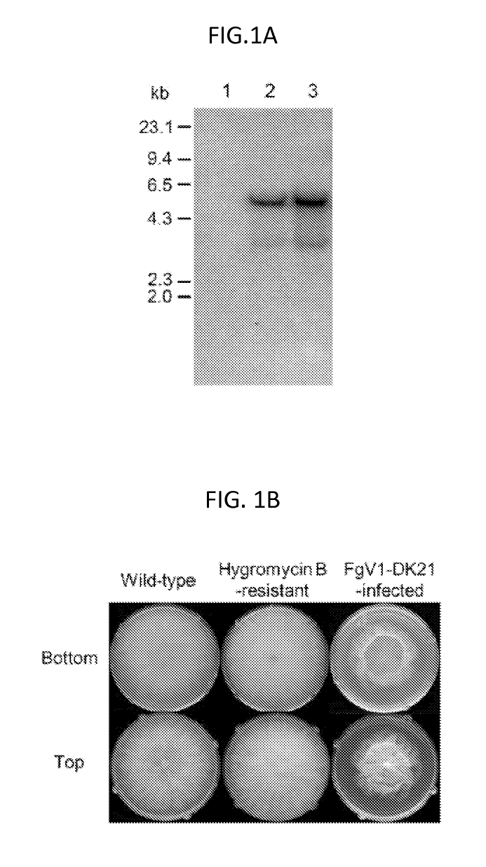

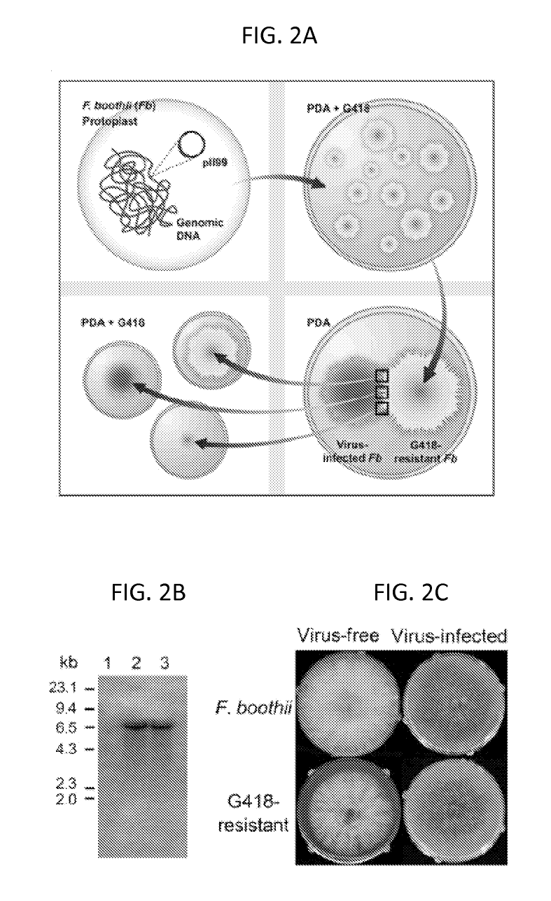

The present inventors first determined whether FgV1-DK21 can overcome the VCG barrier in other Fusarium species. One strain each of two species within the Fg complex [F. asiaticum and F. graminearum], and one strain of F. oxysporum f. sp. lycopersici (outgroup) were chosen (Table 1). To improve screening efficiency of fused protoplasts, virus-free recipients and the virus-infected donors were transformed with hygromycin B- and geneticin-resistance genes, respectively (FIGS. 1A, 1B, 2A, 2B and 2C). After equal volumes of the two protoplast suspensions (1×10⁶ protoplasts/ml) were fused by the 60% polyethylene glycol (PEG 3350)-mediated method, virus-infected strains were finally selected on hygromycin B-containing PDA (see Materials and Methods). Several virus-infected strains (2, 8, and 9) were selected for F. asiaticum, F. graminearum, and F. oxysporum f. sp. lycopersici, respectively (data not shown).

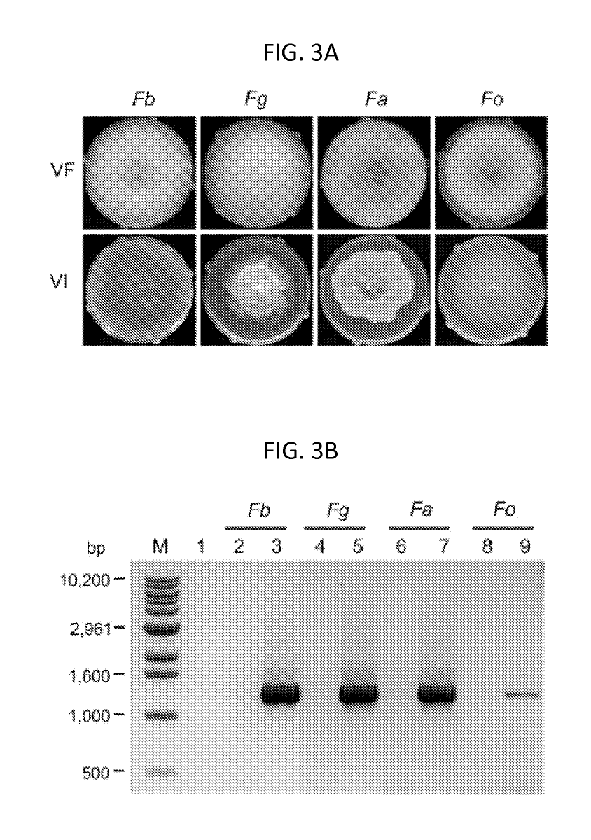

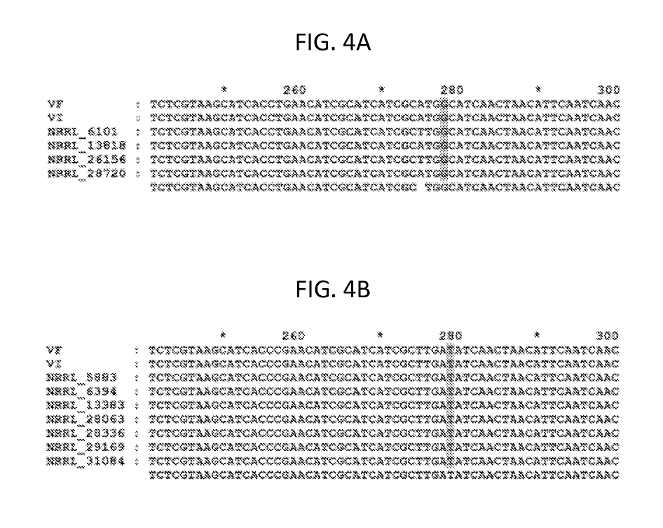

The phenotypic changes of virus-infected strains of F. asiaticum and F. graminearum were similar to those of strain DK21. Like strain DK21, FgV1-DK21 recipient strains of F. asiaticum and F. graminearum had reduced growth rates and increased pigmentation relative to virus-free strains (FIG. 3A). In contrast, only slight morphological alterations were evident in the virus-infected F. oxysporum f. sp. lycopersici strain when growing on PDA (FIG. 3A). However, the FgV1-DK21-infected strains of Fusarium species produced less aerial hyphae than the virus-free strains. FgV1-DK21 dsRNAs were detected in F. graminearum and F. asaticum strains, but not in F. oxysporum f. sp. lycopersici when extracted total RNAs were separated on agarose gel. PCR amplified much more viral dsRNA in the virus-infected strains, F asiaticum and F. graminearum, than in the virus-infected strain of F. oxysporum f. sp. lycopersici (FIG. 4B). The present inventors also sequenced DNA from portions of translation elongation factor 1α (TEF) gene and/or histone H3 gene to determine whether dsRNA of strain DK21 was transferred into the desired recipient strain. The TEF and histone H3 genes have been used as phylogenetic markers to investigate species limits in Fusarium. As a consequence, the fixed nucleotide characters found in the virus-free strains of F. asiaticum (Histone H3 position 278; G) and F. graminearum (Histone H3 position 279; T) were also present in each virus-infected strain (FIGS. 4A and 4B). Although the results indicate that dsRNA of strain DK21 was transferred into the recipient strains, it is unclear whether the altered phenotypes of recipient strains were the result of virus transmission or protoplast fusion because the recipient strains were different in terms of their morphology and in pathogenicity. To address this concern, the present inventors analyzed DNA polymorphism between uninfected and virus-infected strains using amplified fragment length polymorphism (AFLP) profiling. Because the AFLP technique is based on the selective PCR amplification of restriction fragments from a total digest of genomic DNA, it will generate fingerprints of any DNA regardless of the origin or complexity and thus reflect true DNA polymorphisms. The genomic DNAs from virus-free and virus-infected strains were digested with EcoR I and Mse I for AFLP analysis. The digested DNAs were ligated with two adapters and amplified by PCR using specific oligonucleotide primers. Identical AFLP profiles were observed when the present inventors compared the DNA fingerprints among both uninfected and virus-infected samples, indicating that the recipient strains screened from fused protoplasts were not substantially affected by protoplast fusion.

### Example 2

### Hypovirulence of FgV1-DK21 in other Fusarium Species

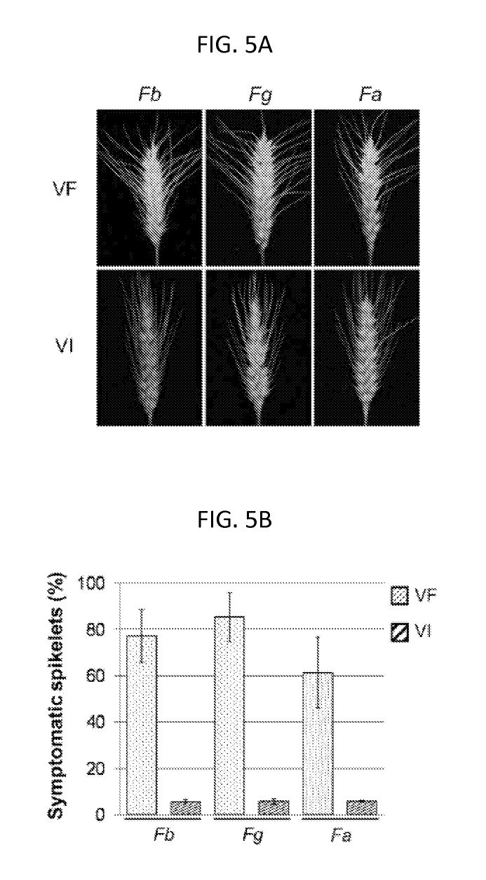

Based on the previous observation that the virulence of strain DK21 was significantly lower than that of the virus-free strain, the present inventors hypothesized that FgV1-DK21 dsRNA might also contribute to the hypovirulence in other Fusarium species. To explore this possibility, wheat head florets were inoculated with conidial suspensions of virus-free or virus-infected strains of F. asiaticum and F. graminearum at early-mid anthesis. Head blight was more severe on wheat plants inoculated with virus-free strains than with virus-infected strains of F. asiaticum and F. graminearum (FIGS. 5A and 5B).

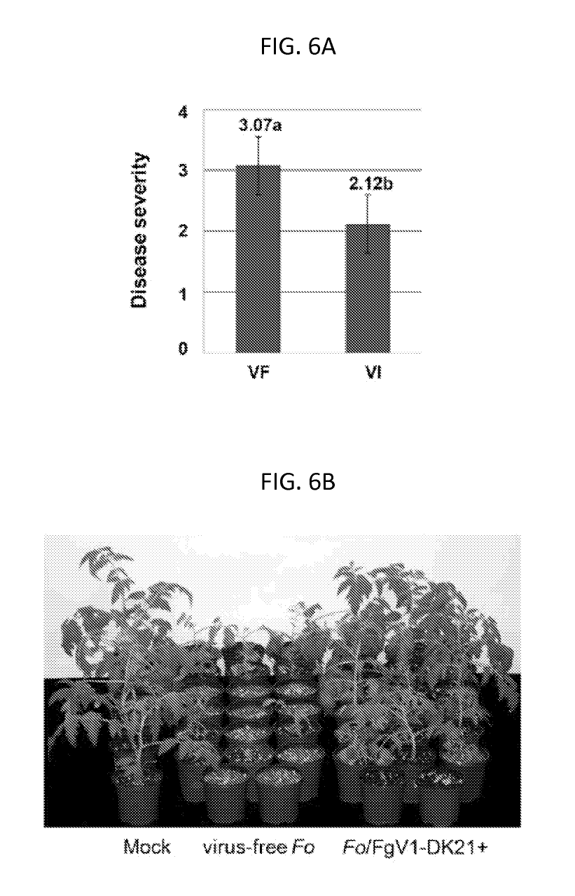

For virulence assays with F. oxysporum f. sp. lycopersici, tomato seedlings growing in pots and at the four-leaf stage were inoculated with virus-free and virus-infected F. oxysporum f. sp. lycopersici strains by the root-dip method. At 3 weeks post-inoculation, seedlings were removed from the pots and their roots were observed for symptoms. Fusarium wilt had developed to the stem base in symptomatic seedlings, and the virus-infected strains were less virulent than the virus-free strains (FIG. 6A). At 4 weeks post inoculation, 46 of 60 plants (76.7%) inoculated with the virus-free strains were dead and 43 of 60 plants (71.7%) inoculated with virus-infected strains remained alive (FIG. 6B).

### Example 3

### Transmission of FgV1-DK21 dsRNA from Strain DK21 to C. parasitica

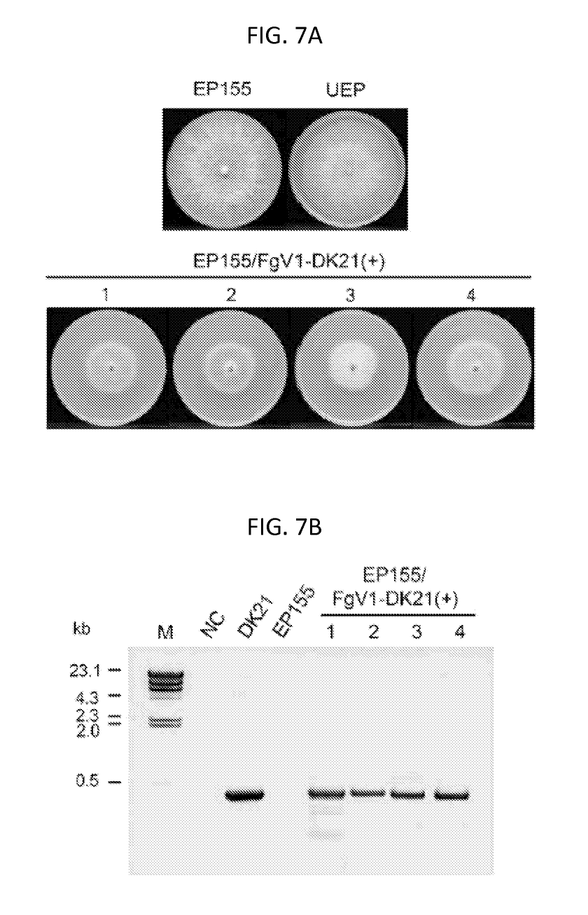

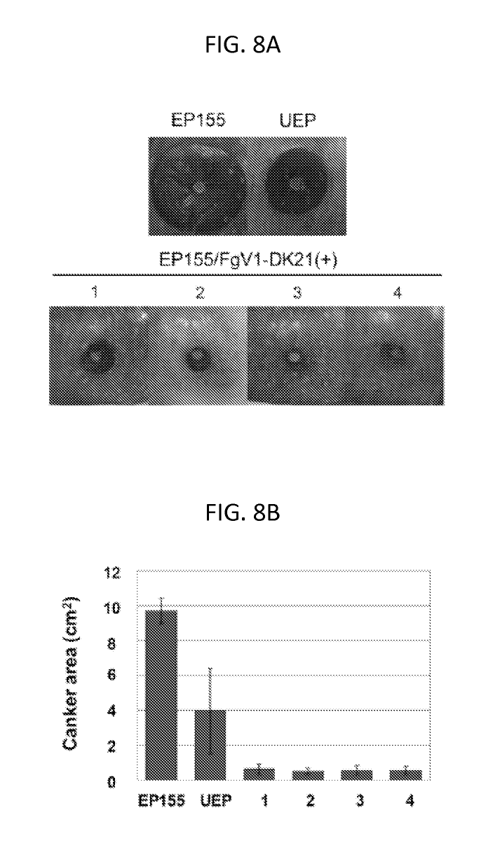

The present inventors also tested whether protoplast fusion can be used to introduce FgV1-DK21 dsRNA into a filamentous fungus of a different genus. Cryphonectria parasitica and associated mycoviruses provide a good model for studying virus/virus and virus/host interactions. For this reason, C. parasitica was subjected to protoplast fusion and evaluated as a potential host of FgV1-DK21. Cryphonectria parasitica strain EP155 was transformed with the hygromycin B resistance gene and fused as a recipient strain with strain DK21 (virus donor) by protoplast fusion. Four strains produced by the fusion procedure were selected and compared with virus-free EP155 and CHV1-infected EP155. CHV1-infected colonies (UEP) were smaller than virus-free colonies and lacked the orange pigment of virus-free colonies (FIG. 7A). Colonies infected by FgV1-DK21 retained the orange color but were much smaller than virus-free EP155 or CHV1-infected EP155 colonies (FIG. 7A). FgV1-DK21 was detected in virus-infected colonies by RT-PCR (FIG. 7B). The present inventors also identified parallel bands among uninfected or virus-infected strains from AFLP profiling indicating that the uninfected and virus-infected strains of EP155 had not been altered significantly by the fusion process. In a virulence test with apples, the areas of lesions caused by virus-free EP155, the CHV1-infected strain, and FgV1-DK21-infected strains were approximately 10, 4, and 0.5 cm², respectively (FIGS. 8A and 8B).

According to the present invention, protoplast fusion can overcome the barriers to transmission caused by genetic diversity and multiple VCGs. Thus, it can extend persistent and transmissible system with application of FgV1-DK21 for fungal disease control. In addition, the composition of the present invention shows hypovirulence in phytopathogenic fungi belonging to Fusarium sp fungi, and thus can be used as an agricultural chemical composition in various plants which are damaged by Fusarium sp. fungi.

While the present invention has been described with reference to the preferred embodiments, it will be understood by those skilled in the related art that various modifications and variations may be made therein without departing from the scope of the present invention as defined by the appended claims.

### REFERENCES

1. Nuss D L (1992) Biological control of chestnut blight: an example of virus mediated attenuation of fungal pathogenesis. Microbiol. Rev 56: 561-576.
2. Shain L, Miller J B (1992) Movement of cytoplasmic hypovirulence agents in chestnut blight cankers. Can J Bot 70: 557-561.
3. Chen B, Chen C-H, Bowman B H, Nuss D L (1996) Phenotypic changes associated with wild-type and mutant hypovirus RNA transfection of plant pathogenic fungi phylogenetically related to Cryphonectria parasitica. Phytopathology 86: 301-310.
4. Peberdy J F (1980) Protoplast fusion—a tool for genetic manipulation and breeding in industrial microorganisms. Enzyme Microb Technol 2: 23-29.
5. Leslie J F (1993) Fungal vegetative compatibility. Annu Rev Phytopathol 31:127-150.
6. Aoki N, Moriyama H, Kodama M, Arie T, Teraoka T, et al. (2009) A novel mycovirus associated with four double-stranded RNAs affects host fungal growth in Alternaria alternata. Virus Res 140: 179-187.
7. Chiba S, Salaipeth L, Lin Y-H, Sasaki A, Kanematsu S, et al. (2009) A novel bipartite double-stranded RNA mycovirus from the white root rot fungus Rosellinia necatrix: Molecular and biological characterization, taxonomic considerations, and potential for biological control. J Virol 83: 12801-12812.
8. Herring A S, Bevan E A (1974) Virus-like particles associated with the double-stranded RNA species found in killer and sensitive strains of the yeast Saccharomyces cerevisiae. J Gen Virol 22: 387-394.
9. Pearson M N, Beever R E, Boine B, Arthur K (2009) Mycoviruses of filamentous fungi and their relevance to plant pathology. Mol Plant Pathol 10: 115-128.
10. Nuss D L (2005) Hypovirulence: Mycoviruses at the fungal-plant interface. Nat Rev Microbiol 3: 632-642.
11. Madhosingh C (1994) Production of intraspecific hybrids of Fusarium oxysporum f. sp. radicis-lycopersici and Fusarium oxysporum f. sp. lycopersici by protoplast fusions. J Phytopathol 142: 301-309.
12. van Diepeningen A D, Debets A J M, Hoekstra R F (1998) Infra- and interspecies virus transfer in Aspergilli via protoplast fusion. Fungal Genet Biol 25: 171-180.
13. van Diepeningen A D, Debets A J M, Slakhors S M, Fekete C, Homok L, et al. (2000) Interspecies virus transfer via protoplast fusions between Fusarium poae and black Aspergillus strains. Fungal Genet Newslett 47: 99-100.
14. Kanematsu S, Sasaki A, Onoue M, Oikawa Y, Ito T(2010) Extending the fungal host range of a partitivirus and a mycoreovirus from Rosellinia necatrix by Inoculation of protoplasts with virus particles. Phytopathology 100: 922-930.
15. Chu Y-M, Jeon J-J, Yea S-J, Kim Y-H, Yun S-H, et al. (2002) Double-stranded RNA mycovirus from Fusarium graminearum. Appl Environ Microbiol 68:2529-2534.
16. O'Donnell K, Ward T J, Geiser D M, Kistler H C, Aoki T (2004) Genealogical concordance between the mating type locus and seven other nuclear genes supports formal recognition of nine phylogenetically distinct species within the Fusarium graminearum clade. Fungal Genet Biol 41: 600-623.
17. O'Donnell K, Ward T J, Aberra D, Kistler H C, Aoki T, et al. (2008) Multilocus genotyping and molecular phylogenetics resolve a novel head blight pathogen within the Fusarium graminearum species complex from Ethiopia. Fungal Genet Biol 45: 1514-1522.
18. Kwon S-J, Lim W-S, Park S-H, Park M-R, Kim K-H (2007) Molecular characterization of a dsRNA mycovirus, Fusarium graminearum virus-DK21, which is phylogenetically related to hypoviruses but has a genome organization and gene expression strategy resembling those of plant potexlike viruses. Mol Cells 23: 304-315.
19. Lee T, Oh D-W, Kim H-S, Lee J, Kim Y-H, et al. (2001) Identification of deoxynivalenol- and nivalenol-producing chemotypes of Gibberella zeae by using PCR. Appl Environ Microbiol 67: 2966-2972.
20. Chu Y-M, Lim W—S, Yea S-J, Cho J-D, Lee Y-W, et al. (2004) Complexity of dsRNA mycovirus isolated from Fusarium graminearum. Virus Genes 28: 135-143.
21. Geiser D M, Jime´nez-Gasco MdM, Kang S, Makalowska I, Veeraraghavan N, et al. (2004) FUSARIUM-ID v. 1.0: A DNA sequence database for identifying Fusarium. Eur J Plant Pathol 110: 473-479.
22. Adams G, Johnson N, Leslie E, Hart L P (1987) Heterokaryons of Gibberella zeae formed following hyphal anastomosis or protoplast fusion. Exp Mycol 11: 339-353.
23. Vos P, Hogers R, Bleeker M, Reijans M, van de Lee T, et al. (1995) AFLP: a new technique for DNA fingerprinting. Nucleic Acids Res 23: 4407-4414.
24. Das A, Gokhale D V, Peberdy J F (1989) Protoplast fusion and genetic recombination in intra- and interstrain crossing in Aspergillus niger. Enzyme Microb Technol 11: 2-5.
25. Gokhale D V (1992) Fungal protoplast fusion—A tool for breeding industrial strains. J Sci Ind Res 51: 497-506.
26. Baltz R H (1999) Genetic recombination by protoplast fusion in Streptomyces. J Ind Microbiol Biotechnol 22: 460-471.
27. Rubinder K, Chadha B S, Singh S, Saini H S (2000) Amylase hyper-producing haploid recombinant strains of Thermomyces lanuginosus obtained by intraspecific protoplast fusion. Can J Microbiol 46: 669-673.
28. Wang C, Zhang X, Chen Z, Wen Y, Song Y (2009) Strain construction for enhanced production of spinosad via intergeneric protoplast fusion. Can J Microbiol 55: 1070-1075.
29. Kim C, Choi E C, Kim B K (1997) Protoplast fusion between Lentinula edodes and Coriolus versicolor. Arch of Pharm Res 20: 448-453.
30. Sun Q, Choi G H, Nuss D L (2009) Hypovirus-responsive transcription factor gene prol of the chestnut blight fungus Cryphonectria parasitica is required for female fertility, asexual spore development, and stable maintenance of hypovirus infection. Eukaryotic Cell 8: 262-270.
31. Puhalla J E, Anagnostakis S L (1971) Genetics and nutritional requirements of Endothia parasitica. Phytopathology 61: 169-173.
32. Lee T, Han Y-K, Kim K-H, Yun S-H, Lee Y-W (2002) Tri13 and Tri7 determine deoxynivalenol- and nivalenol-producing chemotypes of Gibberella zeae. Appl Environ Microbiol 68: 2148-2154.
33. Turgeon B G, Garber R C, Yoder O C (1987) Development of a fungal transformation system based on selection of sequences with promoter activity. Mol Cell Biol 7: 3297-3305.
34. Kim J-E, Han K-H, Jin J, Kim H, Kim J-C, et al. (2005) Putative polyketide synthase and laccase genes for biosynthesis of aurofusarin in Gibberella zeae. Appl Environ Microbiol 71: 1701-1708.
35. Hong S-Y, Kang M R, Cho E-J, Kim H-K, Yun S-H (2010) Specific PCR detection of four quarantine Fusarium species in Korea. Plant Pathol J 26: 409-416.
36. Thompson J D, Higgins D G, Gibson T J (1994) CLUSTAL W: improving the sensitivity of progressive multiple sequence alignment through sequence weighting, position-specific gap penalties and weight matrix choice. Nucleic Acids Res 22: 4673-4680.
37. Kanematsu S, Arakawa M, Oikawa Y, Onoue M, Osaki H, et al. (2004) A reovirus causes hypovirulence of Rosellinia necatrix. Phytopathology 94: 561-568.
38. Churchill A C L, Ciuffetti L M, Hansen D R, Van Etten H D, Van Alfen N K (1990) Transformation of the fungal pathogen Cryphonectria parasitica with a variety of heterologous plasmids. Curr Genet. 17: 25-31.
39. Suzuki N, Nuss D L (2002) Contribution of protein p40 to hypovirus-mediated modulation of fungal host phenotype and viral RNA accumulation. J Virol 76: 7747-7759.
40. Seong K, Hou Z, Tracy M, Kistler H C, Xu J-R (2005) Random insertional mutagenesis identifies genes associated with virulence in the wheat scab fungus Fusarium graminearum. Phytopatholo 95: 744-750.
41. Di Pietro A, Roncero M I (1998) Cloning, expression, and role in pathogenicity of pg1 encoding the major extracellular endopolygalacturonase of the vascular wilt pathogen Fusarium oxysporum. Mol Plant-Microbe Interact 11: 91-98.
42. Fulbright D W (1984) Effect of eliminating dsRNA in hypovirulent Endothia parasitica. Phytopatholo 74: 722-724.

What is claimed is:

1. A fungus for biological control, having an infectious Fusarium virus transmitted thereto.

2. The fungus of claim 1, wherein the infectious Fusarium virus is any one virus selected from the group consisting of Fusarium graminearum virus 2, Fusarium graminearum virus 3, and Fusarium graminearum virus 4.

3. The fungus of claim 1, wherein the infectious Fusarium virus is Fusarium graminearum virus 1-DK21 (FgV1-DK21).

4. The fungus of claim 1, wherein the fungus is a Fusarium sp. fungus having the infectious Fusarium virus transmitted thereto.

5. The fungus of claim 1, wherein the fungus is Cryphonectria parasitica having the infectious Fusarium virus transmitted thereto.

6. The fungus of claim 4, wherein the Fusarium sp. fungus is F. asiaticum or F. oxysporum f. sp. lycopersici.

7. A composition for biological control comprising the fungus of claim 1.

8. A composition for biological control comprising the fungus of claim 5.

9. A composition for biological control comprising the fungus of claim 6.

10. A method for biological control, comprising bringing virulent wild-type species into contact with the fungus of claim 1.

11. A method for biological control, comprising bringing virulent wild-type species into contact with the fungus of claim 5.

12. A method for biological control, comprising bringing virulent wild-type species into contact with the fungus of claim 6.

13. The method of claim 10, wherein the virulent wild-type species is a Fusarium sp. strain.

14. The method of claim 13, wherein the virulent wild-type species is F. asiaticum or F. oxysporum f. sp. lycopersici.

15. The method of claim 10, wherein the virulent wild-type species is Cryphonectria parasitica.

16. A method of transmitting an infectious Fusarium virus to a vegetatively incompatible strain, comprising:
preparing a protoplast of a donor strain comprising the Fusarium virus and a protoplast of a recipient strain;
fusing the protoplast of the donor strain with the protoplast of the recipient strain; and
selecting an Fusarium virus-infected strain on a selective medium.

17. The method of claim 16, wherein the infectious Fusarium virus is any one virus selected from the group consisting of Fusarium graminearum virus 2, Fusarium graminearum virus 3, and Fusarium graminearum virus 4.

18. The method of claim 16, wherein the infectious Fusarium virus is Fusarium graminearum virus 1-DK21 (FgV1-DK21).

19. The method of claim 16, wherein the strain is a Fusarium sp. strain.

20. The method of claim 19, wherein the strain is Cryphonectria parasitica.

21. The method of claim 19, wherein the Fusarium sp. strain is F. asiaticum or F. oxysporum f. sp. lycopersici.


SEQUENCE LISTING (4 sequences)

SEQ ID NO: 1 - DNA, 22 bp, Artificial Sequence
  Primer
tgtgggagaagaagtatggcct

SEQ ID NO: 2 - DNA, 23 bp, Artificial Sequence
  Primer
atcaggaaccattgaaagagtcc

SEQ ID NO: 3 - DNA, 20 bp, Artificial Sequence
  Primer
atggacaccaaggatattta

SEQ ID NO: 4 - DNA, 22 bp, Artificial Sequence
  Primer
ttaggggtgcaaggcccttttc